(19) United States
(12) Patent Application Publication
(10) Pub. No.: US 2025/0236062 A1
(43) Pub. Date: Jul. 24, 2025

(54) METHOD FOR PRODUCING A DETERGENT-PORTION UNIT

(71) Applicant: HENKEL AG & CO. KGAA, Düsseldorf (DE)

(72) Inventors: Uwe TREBBE, Düsseldorf (DE); Niklas SIEPLER, Wuppertal (DE)

(21) Appl. No.: 18/853,632

(22) PCT Filed: Jan. 17, 2023
(86) PCT No.: PCT/EP2023/051009

§ 371 Date: Oct. 2, 2024

(30) Foreign Application Priority Data
Apr. 4, 2022 (EP) 22166469.1

(51) Int. Cl. B29C 51/06; B29C 51/10; B29C 51/42; B29K 29/00; B29L 25/00; B29L 31/00; B65B 3/02; B65B 29/00

(52) U.S. Cl. CPC B29C 51/06; B29C 51/10; B29C 51/422; B65B 3/022; B65B 29/00; B29C 2791/006; B29K 2029/04; B29K 2995/0062; B29K 2995/0097; B29L 2025/00; B29L 2031/712; B29L 2031/773; B29L 2031/7734

(57) ABSTRACT

A method for producing a portion unit with at least one filled receiving chamber surrounded by a film, comprising the steps of a) transporting a first film in the direction of a heating device; b) bringing the first film into contact with a surface of the heating device; c) heating the first film by means of the heating device; d) breaking the contact between the first film and the heating device; e) molding the first heated film into the cavities of a thermoforming mold, thereby forming a receiving container with at least one receiving chamber; f) filling the at least one receiving chamber; g) optionally closing and separating the filled receiving containers, thereby forming the portion unit, wherein the region on the surface of the heating device that is brought into contact with the film has at least one depression and, in step b), the at least one depression is covered by the subregions of the first film that are molded into the cavity of the thermoforming mold in step e).

The present invention relates to a method for producing portion units, in particular detergent or cleaning agent portion units, comprising at least one receiving chamber formed by a film material.

Continuously changing requirements are placed on the forms of manufacture and supply of consumer goods. In the field of detergents or cleaning agents, for example, attention has been paid for some time to their more convenient dosing by the consumer and the simplification of the work steps necessary to carry out a washing or cleaning method. A technical solution is provided by pre-portioned detergents or cleaning agents, for example film pouches comprising one or more receiving chambers for solid or liquid detergents or cleaning agents.

A trend relevant to the production of these film pouches is the miniaturization of these film pouches. In addition to higher consumer acceptance due to simplified handling, the background of this development is, in particular, sustainability aspects, for example with respect to the quantity of packaging materials used.

The film pouches described above are produced by multi-stage processes, in the course of which water-soluble film materials are molded in cavities, for example by the action of heat and negative pressure, filled, and subsequently sealed. While heating the films increases their plasticity, the force resulting from the negative pressure applied to the heated film causes the film to stretch and plastically deform. In this method, the film is not homogeneously stretched over its surface, but rather regions of high stretching, for example in the rim region of the cavity, alternate with regions of lower stretching. A deformed film in the form of a receiving container having a heterogeneous film thickness distribution is thus produced from a film material having a homogeneous film thickness. The more intensely the original film material is deformed, the more pronounced this heterogeneous film thickness distribution becomes. The intensity of the deformation generally increases, for example, with the number or depth of the receiving chambers that are molded into the receiving container.

In addition to other factors, both the film thickness distribution and the absolute film thickness determine the haptic, visual and mechanical properties of the film pouch. Film pouches having large differences in the film thickness are often perceived as less attractive. Film pouches having a low minimal film thickness deform more easily under their own weight than corresponding film pouches having a higher film thickness and appear limp. These film pouches withstand mechanical load to a lesser extent and dissolve too quickly when water is added. The two last-mentioned properties not only are relevant to film pouches in the area of production, transport, and storage but also in particular affect product safety, for example in the event of inadvertent oral consumption.

In order to increase the homogeneity of the wall thickness in the case of deep-drawing methods, the international application WO 2019/206448 A1 proposes a deep-drawing method in the course of which a temperature profile is applied to a flat film.

With the same objective, methods using heating devices having a heterogeneous temperature distribution are proposed in European patent application EP2298536 A2 and international patent application WO 2020/1520441 A1.

However, these previously described solution approaches are complex in terms of equipment and are only suitable for high throughputs to a limited extent. Furthermore, the device, just as the changeover of corresponding deep-drawing lines, is costly.

Against this technical background, the object addressed by the application was that of providing a method for producing portion units, which, with minimal equipment cost and with minimal use of film materials used for packaging purposes, facilitates the efficient production of portion units with maximum stability and an attractive appearance and haptics.

A first application subject matter is a method for producing a portion unit having at least one filled receiving chamber surrounded by a film, comprising the steps of:
a) transporting a first film in the direction of a heating device;
b) bringing the first film into contact with a surface of the heating device;
c) heating the first film using the heating device;
d) breaking the contact between the first film and the heating device;
e) molding the first heated film into the cavities of a deep-drawing die to form a receiving container comprising at least one receiving chamber;
f) filling the at least one receiving chamber;
g) optionally sealing and separating the filled receiving containers to form the portion unit,
   wherein the surface region of the heating device that is brought into contact with the film has at least one depression and the at least one depression is covered in step b) by the subregions of the first film which are molded into the cavity of the deep-drawing die in step e).

The method according to the invention allows the efficient production of the washing agent portion units. Due to a uniform thickness of the water-soluble film, the detergent portion units are characterized by high mechanical stability with minimal use of packaging means as well as attractive haptics and appearance.

In the context of the method according to the invention, preferably water-soluble films are formed in a deep-drawing apparatus and combined with detergent preparations to form detergent portion units.

The water-soluble film may comprise one or more structurally different water-soluble polymer(s). Suitable water-soluble polymer(s) for the first water-soluble film are in particular polymers from the group of (optionally acetalized) polyvinyl alcohols (PVAL) and copolymers thereof.

Water-soluble films for producing the portion unit are preferably based on a polyvinyl alcohol or a polyvinyl alcohol copolymer of which the molecular weight is preferably in the range of 10,000 to 1,000,000 gmol⁻¹, preferably of 20,000 to 500,000 gmol⁻¹, particularly preferably of 30,000 to 100,000 gmol⁻¹, and in particular of 40,000 to 80,000 gmol⁻¹. Preferred water-soluble films comprise at least 30 wt. %, preferably at least 50 wt. %, and in particular at least 70 wt. %, polyvinyl alcohol or polyvinyl alcohol copolymers.

The production of the polyvinyl alcohol and polyvinyl alcohol copolymers generally includes the hydrolysis of intermediate polyvinyl acetate. Preferred polyvinyl alcohols and polyvinyl alcohol copolymers have a degree of hydrolysis of 70 to 100 mol. %, preferably 80 to 90 mol. %, particularly preferably 81 to 89 mol. %, and in particular 82 to 88 mol. %.

Preferred polyvinyl alcohol copolymers comprise, in addition to vinyl alcohol, an ethylenically unsaturated carboxylic acid, or the salt or ester thereof. In addition to vinyl alcohol, such polyvinyl alcohol copolymers particularly preferably contain sulfonic acids, such as 2-acrylamido-2-methyl-1-propanesulfonic acid (AMPS), acrylic acid, methacrylic acid, acrylic acid esters, methacrylic acid esters or mixtures thereof; among the esters, preference is given to C₁₋₄ alkyl esters or hydroxyalkyl esters. Ethylenically unsaturated dicarboxylic acids, for example itaconic acid, maleic acid, fumaric acid and mixtures thereof, are possible as further monomers.

Suitable water-soluble films for use in the portion units according to the invention are films which are sold by MonoSol LLC, for example under the designations M8630, M8720, M8310, C8400 or M8900. Other suitable films include films having the designation Solublon® PT, Solublon® GA, Solublon® KC or Solublon® KL from Aicello Chemical Europe GmbH, or the VF-HP films from Kuraray, and the Hi-Selon series from Mitsubishi Chemical Corporation.

The first, preferably water-soluble film preferably has a thickness of 10 to 90 μm, preferably of 30 to 60 μm.

The water-soluble films can contain additional active ingredients or fillers, but also plasticizers and/or solvents, in particular water, as further ingredients.

In this case, the group of the further active ingredients includes, for example, materials which protect the ingredients of the detergent that are surrounded by the film material from decomposition or deactivation by light irradiation. Antioxidants, UV absorbers and fluorescent dyes have proven to be particularly suitable here.

As plasticizers, it is possible to use, for example, glycerol, ethylene glycol, diethylene glycol, propanediol, 2-methyl-1,3-propanediol, sorbitol or mixtures thereof.

To reduce the coefficients of friction thereof, the surface of the water-soluble film of the detergent portion unit can optionally be powder-coated with fine powder. Sodium aluminosilicate, silicon dioxide, talc and amylose are examples of suitable powdering agents.

The deep-drawing apparatus used in the method can be operated continuously or discontinuously. A continuous procedure is preferred for increasing the efficiency of the method. In a particularly preferred embodiment of the method, the first, preferably water-soluble film is transported continuously in step a). With regard to the economy and safety of the method, it is preferred for the first, preferably water-soluble film to be transported at a speed of 0.04 m/s, preferably above 0.08 m/s, in step a).

The surface region of the heating device which surrounds the depression and with which the film is brought into contact in step b), is preferably planar. Particularly preferred materials for manufacturing the surface of the heating device with which the water-soluble film is in contact in step b) are ceramic or metal, in particular aluminum.

Preferred heating devices have a metallic surface, in particular a metallic surface which comprises aluminum. Due to their heat-conducting properties, metallic heating device surfaces which consist of at least 70 wt. %, preferably at least 90 wt. %, particularly preferably at least 98 wt. %, and in particular completely, of aluminum are preferred.

The planar surface regions of the heating device can be textured to control the heat transfer or to prevent adhesions. Such textured surfaces have, for example, visible or noticeable irregularities, such as grooves. The texture elements differ from the depressions, of course, with regard to their depth and their width. In preferred textured surface regions, the maximum depth of the texture elements is less than 0.5 mm, preferably less than 0.2 mm, and in particular less than 0.1 mm. The maximum depth corresponds to the maximum length of a distance, orthogonal to the opening area, between a point on the opening area and a point on the bottom surface of the texture element.

Preferred heating devices have a peripheral edging. The edging encloses the planar surface region and the depression formed in this surface region, or the depressions formed in this surface region. Preferably, at least four, preferably at least eight and in particular at least sixteen depressions are enclosed by the edging.

A film brought over the heating device is spaced apart from the heated surface by means of the edging. A contact between the film and the surface of the heating device thereby occurs only by a targeted application of force, for example by applying a negative pressure between the heating device surface and the film. As a result, the contact times between the heated surface and the film can be controlled in a targeted manner even at high process speeds. Since the described effect of this spacing is less pronounced at a low edging height, while the effect of the negative pressure used is reduced at a high edging height, the height of the edging is preferably 0.5 to 2 mm, particularly preferably 0.8 to 1.2 mm. An edging height of 1 mm is very particularly preferred.

In summary, a preferred method variant is characterized in that the surface region of the heating device that surrounds the depression has a planar design and is enclosed by a peripheral edging having a height of 0.5 to 2 mm, preferably of 0.8 to 1.2 mm.

With respect to the desired homogeneous film expansion, it has proven to be advantageous if the opening area of the at least one depression is smaller than the opening area of the cavity. In preferred methods, the opening area of the at least one depression is 40 to 95%, preferably 50 to 90%, and in particular 60 to 80%, of the opening area of the cavity.

In order to achieve homogeneous film expansion, it is furthermore advantageous to model the outline of the opening area of the depression on the outline of the opening area of the cavity. The two-dimensional shape of the opening area of a depression is referred to as a replication and resembles the two-dimensional shape of the opening area of the cavity, for example with respect to the number of corners present.

It is particularly preferred if the outline of the opening area of the depression is obtained from the outline of the opening area of the cavity by a reduction, wherein preferably reducing factors of 0.4 to 0.95, preferably of 0.5 to 0.9, and in particular of 0.6 to 0.8 are applied.

Preferred depressions have an opening area with a maximum diameter of 10 to 40 mm, preferably of 20 to 35 mm. The maximum depth of preferred depressions is 0.5 to 7 mm, preferably 0.8 to 4 mm. The maximum depth corresponds to the maximum length of a distance, orthogonal to the opening area, between a point on the opening area and a point on the bottom surface of the depression.

The depressions can have different three-dimensional shapes. In addition to the rim of the opening area, preferred depressions have at most one further rim. It is furthermore preferred if the depressions have no side surfaces orthogonal to the opening area. Rather, depressions which are delimited exclusively by their opening area and a bottom surface directly adjoining the opening area are preferred. Particularly preferred depressions have, for example, a hemispherical, compressed hemispherical, elongated hemispherical or a compressed and elongated hemispherical three-dimensional shape. The bottom surface can be flattened, for example in the form of a region plane-parallel to the opening area.

Preferred depressions are characterized by a bottom surface which continuously decreases from its rim to its lowest point. Of course, the depression can have more than one lowest point. For example, as described above, the depression can have a bottom surface that is partially plan-parallel to the opening area. In such an embodiment, the bottom surface has a continuous gradient between the rim of the depression and the rim of the plan-parallel region of the bottom surface.

The gradient can run linearly or nonlinearly. Both the absolute gradient and its relative course have proven to be relevant to the film thickness homogeneity that is achieved. Preferred depressions have a bottom surface which continuously decreases from its rim down to its lowest point and whose gradient on the shortest route from the rim down to the lowest point runs linearly over at least 10%, preferably 30% of the distance. For example, method variants with the use of depressions which have a bottom surface which continuously decreases from its rim down to its lowest point and whose gradient on the shortest route from the rim down to the lowest point runs linearly over 10 to 90%, preferably of 30 to 80% of the distance have proven to be advantageous.

It is preferred if the depression has a bottom surface which continuously decreases from its rim to its lowest point and whose gradient on the shortest route from the rim down to the lowest point changes at least at one point.

Preferably, the depression has a bottom surface which continuously decreases from its rim down to its lowest point and whose gradient on the shortest route from the rim down to the lowest point is 10 to 50%, preferably 15 to 40% over the entire distance.

The volume of preferred depressions is preferably from 1 to 8 ml, preferably from 1 to 6 ml.

The ratio of the maximum depth of the depression in step b) to the maximum depth of the cavity in step e) is preferably 2:3 to 1 to 5, particularly preferably 1:2 to 1:4. A corresponding ratio has proven advantageous both with regard to the homogeneity of the film thickness distribution and with respect to the process control.

The method according to the invention is particularly suitable for producing portion units having complex geometries or for portion units comprising more than one receiving chamber. In a preferred embodiment of the method, the portion unit therefore has at least two, preferably at least three, and in particular at least four, receiving chambers, wherein the heating device has a number of depressions corresponding to the number of receiving chambers, which depressions are covered in step b) by the subregions of the first film which are molded into the cavity of the deep-drawing die in step e) to form the at least two, preferably at least three, and in particular at least four, receiving chambers.

If portion units comprising two or more receiving chambers are produced, the receiving chambers can be identical with respect to their three-dimensional shape or the dimensions thereof but can also differ. The advantages of the method according to the invention with respect to the achievement of homogeneous film thickness distributions are also in particular obvious in the production of portion units by means of heating devices which have at least two depressions that differ with regard to their maximum depth.

The surface of the heating device preferably has a planar design between two adjacent depressions associated with a portion unit. The minimum distance between two such adjacent depressions is preferably 0.5 to 4 mm, preferably 1 to 3 mm.

In a preferred embodiment, the two, three, or four receiving chambers and consequently also the depressions associated with the receiving chambers are arranged so as to surround one another at least partially. This procedure is realized, for example, during the production of portion units comprising at least two, preferably at least three, and in particular at least four, receiving chambers, the one chamber of which forms a central point about which the remaining chambers are arranged in a rotationally symmetrical manner.

As stated at the outset, the heating device preferably has a metallic surface. This preferably metallic surface in turn has depressions which, at minimal equipment cost and with minimal use of film materials used for packaging, enable the efficient production of portion units with maximum stability and attractive appearance and haptics.

These advantageous properties of the method according to the invention can be intensified by an at least partial coating of the surface of the heating device. It is particularly advantageous here to at least partially coat the surface of the heating device in the region of the depression. Like the depressions located in the surface, a corresponding coating influences the film thickness distribution of the receiving containers produced. It has proven advantageous in this context to coat the surface of the heating device over the entire surface in the region of the depression(s).

The coating can extend onto the surface of the heating device in the region of the depression(s) and the rim region surrounding the depression.

The coating of the heating device surface in the region of the depressions necessarily leads to an at least partial filling of the depression volume. In variants of the method according to the invention, the at least one depression is filled with a coating material to at least 60 vol. %, preferably at least 80 vol. %, and in particular completely.

The coating can cover 5 to 80%, preferably 10 to 70%, and in particular 20 to 50%, of the surface region of the heating device which is brought into contact with the film in step b).

Coating materials from the group of metals and polymers, in particular rubbers and silicones, are suitable as material for the coating. The coating with silicones is particularly preferred due to their heat resistance and moldability.

Preferred coating compositions have a lower thermal conductivity and/or a lower heat transfer coefficient than the heating device surface.

The thickness of the coating is preferably 100 to 4000 μm, and particularly preferably 200 to 2000 μm.

Any coatings can be joined to the base surface in various ways. Thus, adhesive joints are suitable for forming a lasting and temporally locally stable bond between the heating device surface and the coating agent. Clamping or plug connections are in turn preferably used in the cases in which a rapid exchangeability of the coating agents, for example due to wear or to the change in the process parameters, is sought.

For the film thickness distribution of the method's product, it has proven to be advantageous if the coating in step b) is in contact with the surface portion of the water-soluble film which is molded into the cavity of the deep-drawing depression in step e).

In a preferred method variant, the first film is brought into contact with the heating device only on one side in step b). Compared to methods using two heating devices, the method according to the invention is thus not only associated with a lower equipment cost but also allows a more compact design of the production line.

Preferably, in step b), the upper side of the film is brought into contact with the heating device. The side of the film that is spatially oriented upward is referred to as the upper side. For this purpose, the heating device is preferably lowered in the direction of the film in step b).

In order to reduce the process duration and to ensure reproducible contact between the first water-soluble film and the surface of the heating device, the film is brought into contact with the heating device in step b) by means of a negative pressure. Furthermore, it is preferred to maintain the contact between the film and the heating device by maintaining a negative pressure. The height of a corresponding negative pressure, which is built up in step b) between heating device and film, is preferably 200 to 800 mbar and in particular 400 to 700 mbar.

In order to support the uniform formation of a negative pressure between heating device and water-soluble film, the surface of the heating device preferably has bores by means of which gas located between heating device and film can be discharged. These bores are preferably 60%, preferably 90%, in particular 95%, and very particularly preferably completely outside the depressions.

In step c), the film is preferably heated for a period of 0.5 to 7 seconds, preferably 1 to 6 seconds, and in particular 2 to 5 seconds.

The metallic surface of the heating device preferably has a temperature in the range of 23 to 150° C., preferably of 80 to 135° C. It is particularly preferred if the surface of the heating device in the region of the elevation(s) with which the water-soluble film is in contact in step b) has a temperature in the range of 90 to 150° C., preferably of 110 to 135° C.

For further adaptation of the expansion factors of the different portions of the water-soluble film forming the receiving container, it has furthermore proven to be advantageous if the at least one elevation in step c) is in contact with all surface portions of the water-soluble film which form the rim region of the receiving chamber(s) of the receiving container. For the same reasons, it is preferred that the surface portions of the water-soluble film which form the bottom region of the receiving chamber(s) of the receiving container are not in contact with the heating device in step c).

In order to increase the method efficiency and to increase the film thickness homogeneity within the scope of the method according to the invention, it has proven to be advantageous if the film is located in step c) between the heating device and the deep-drawing die used in step e), preferably below the heating device and above the deep-drawing die used in step e), wherein the distance between the surface of the heating device and the deep-drawing die is preferably less than 10 mm, preferably less than 5 mm, in particular 0.1 to 2 mm, and particularly preferably 0.2 to 1 mm.

In step d), the contact between the first water-soluble film and the surface of the heating device is broken. For this purpose, the negative pressure possibly acting between the heating device and the film is eliminated. In a particularly preferred embodiment of the method, a negative pressure generated beforehand between the heating device and the film is eliminated in step d) and the heating device is simultaneously or subsequently raised.

At the beginning of step e), the film preferably has a temperature above its glass transition temperature.

In step e), the film is molded into the cavity of a deep-drawing die. For this purpose, a negative pressure is preferably built up between the film and the deep-drawing die for the duration of 0.5 to 7 seconds, preferably 1 to 5 seconds. This negative pressure generated between the film and the deep-drawing die is preferably 100 to 600 mbar and in particular 200 to 400 mbar.

During the molding into the cavity of the deep-drawing die, the surface of the water-soluble film is preferably increased by at least 80%, preferably by at least 120%, in particular by 120 to 300%, particularly preferably by 180 to 260%. Accordingly, after step e), the film has an overall stretching factor of preferably at least 1.2, preferably 1.2 to 3.0, and in particular 1.8 to 2.6. At the same time, the maximum local stretching factor of the water-soluble film is preferably 1.8 to 4, particularly preferably 2 to 2.8, after step e).

It is preferred in particular if the water-soluble film is molded in step e) to form a receiving container comprising at least two, preferably at least three, and in particular at least four, receiving chambers.

The receiving chamber(s) formed in step e) preferably have a filling volume of 2 to 8 ml, particularly preferably of 3 to 7 ml. The filling volume of the receiving container in step e) is preferably 2 to 50 ml, preferably 10 to 40 ml, and in particular 13 to 25 ml.

In preferred method variants in which the receiving container has at least two, preferably at least three, and in particular at least four, receiving chambers, the ratio of the volume of the largest receiving chamber to the volume of the smallest receiving chamber is 4:1 to 1:1, preferably 3:1 to 1:1.

For reasons of process efficiency, the method according to the invention is designed in such a way that, in a method run, not just a single detergent agent portion unit but rather a plurality of detergent agent portion units is produced in parallel. A two-dimensional structure comprising at least 14, preferably at least 20, receiving containers is preferably formed in step e).

In this two-dimensional structure, the receiving containers are preferably arranged in rows. With regard to the subsequent filling, the two-dimensional structures formed in step e) are preferably arranged in rows which are arranged orthogonally to the transport direction of the water-soluble film.

In an alternative embodiment, a two-dimensional structure in which the receiving containers are arranged in rows which run orthogonally to the transport direction of the water-soluble film and are respectively offset from one another by a third of the width of a receiving container, preferably by half the width of a receiving container, is formed in step e).

In the two-dimensional structure, the receiving containers are preferably arranged in such a way that each receiving container is adjacent to at least one intermediate region, which in turn is surrounded by three receiving containers.

The at least one receiving chamber of the receiving container is filled in step f). Solid and liquid detergents or cleaning agents are suitable for the filling operation.

In particular in cases in which the filled detergents or cleaning agents are not adhesively joined to the water-soluble film material, as can be the case, for example, in melts, the filled receiving chamber of the receiving container is sealed.

Corresponding methods in the course of which the receiving chamber of the receiving container is filled in a further step f) and the filled receiving chamber is sealed by means of a second water-soluble film in a subsequent step g) are preferred with regard to the product aesthetics and product handling capability.

This application provides, inter alia, the following subjects:
1. A method for producing a portion unit having at least one filled receiving chamber surrounded by a film, comprising the steps of:
   a) transporting a first film in the direction of a heating device;
   b) bringing the first film into contact with a surface of the heating device;
   c) heating the first film using the heating device;
   d) breaking the contact between the first film and the heating device;
   e) molding the first heated film into the cavities of a deep-drawing die to form a receiving container comprising at least one receiving chamber;
   f) filling the at least one receiving chamber;
   g) optionally sealing and separating the filled receiving containers to form the portion unit,
      wherein the surface region of the heating device that is brought into contact with the film, which has at least one depression, and the at least one depression is covered in step b) by the subregions of the first film which are molded into the cavity of the deep-drawing die in step e).
2. The method according to point 1, wherein the surface region of the heating device that surrounds the depression has a planar design.
3. The method according to one of the preceding points, wherein the surface region of the heating device surrounding the depression is designed to be flat and has a textured surface, the texture elements of which preferably have a maximum depth of less than 0.5 mm, preferably less than 0.2 mm, and in particular less than 0.1 mm.
4. The method according to one of the preceding points, wherein the surface region of the heating device that surrounds the depression has a planar design and is enclosed by a peripheral edging having a height of 0.5 to 2 mm, preferably of 0.8 to 1.2 mm,
5. The method according to one of the preceding points, wherein the opening area of the at least one depression is smaller than the opening area of the cavity.
6. The method according to one of the preceding points, wherein the opening area of the at least one depression is 40 to 95%, preferably 50 to 90%, and in particular 60 to 80%, of the opening area of the cavity.
7. The method according to one of the preceding points, wherein the outline of the opening area of the depression is modeled on the outline of the opening area of the cavity.
8. The method according to one of the preceding points, wherein the outline of the opening area of the depression is obtained from the outline of the opening area of the cavity by a reduction factor of 0.4 to 0.95, preferably of 0.5 to 0.9, and in particular of 0.6 to 0.8.
9. The method according to one of the preceding points, wherein the depression has an opening area with a maximum diameter of 10 to 40 mm, preferably of 20 to 35 mm.
10. The method according to one of the preceding points, wherein the depression has a maximum depth (measured as an orthogonal distance between the opening area and the bottom surface of the depression) from 0.5 to 7 mm, preferably from 0.8 to 4 mm.
11. The method according to one of the preceding points, wherein the depression has a hemispherical, compressed hemispherical, elongated hemispherical or compressed and elongated hemispherical three-dimensional shape.
12. The method according to one of the preceding points, wherein the bottom surface of the depression is flattened and preferably runs plan-parallel to the opening area.
13. The method according to one of the preceding points, wherein the depression has a bottom surface which continuously descends from its rim down to its lowest point.
14. The method according to one of the preceding points, wherein the depression has a bottom surface which continuously descends from its rim down to its lowest point and whose gradient on the shortest route from the rim down to the lowest point runs linearly over at least 10%, preferably 30%, of the route.
15. The method according to one of the preceding points, wherein the depression has a bottom surface which continuously descends from its rim down to its lowest point and whose gradient on the shortest route from the rim down to the lowest point runs linearly over 10 to 90%, preferably 30 to 80%, of the route.
16. The method according to one of the preceding points, wherein the depression has a bottom surface which continuously decreases from its rim down to its lowest point and whose gradient on the shortest route from the rim down to the lowest point changes at least at one point.
17. The method according to one of the preceding points, wherein the depression has a bottom surface which continuously decreases from its rim down to its lowest point and whose gradient on the shortest route from the rim down to the lowest point is 10 to 50%, preferably 15 to 40%, over the entire route.
18. The method according to one of the preceding points, wherein the depression has a volume of 1 to 8 ml, preferably of 1 to 6 ml.
19. The method according to one of the preceding points, wherein the ratio of the maximum depth of the depression in step b) to the maximum depth of the cavity in step e) is preferably 2:3 to 1 to 5, particularly preferably 1:2 to 1:4.
20. The method according to one of the preceding points, wherein the portion unit has at least two, preferably at least three, and in particular at least four, receiving chambers, wherein the heating device has a number of depressions corresponding to the number of receiving chambers, which depressions are covered in step b) by the subregions of the first film which are molded into the cavity of the deep-drawing die in step e) to form the at least two, preferably at least three, and in particular at least four, receiving chambers.
21. The method according to point 20, wherein at least two of the depressions differ with regard to their maximum depth.
22. The method according to point 21, wherein the heating device has a planar design between the depressions.
23. The method according to one of points 20 to 22, wherein the heating device between the depressions has a planar design and the minimum distance between two depressions is 0.5 to 4 mm, preferably 1 to 3 mm.
24. The method according to one of points 20 to 23, wherein the at least two, preferably at least three, and in particular at least four, receiving chambers surround one another at least partially.
25. The method according to one of points 20 to 24, wherein the portion unit has at least two, preferably at least three and in particular at least four receiving chambers, one chamber of which forms a central point around which the remaining chambers are arranged rotationally symmetrically.
26. The method according to one of the preceding points, wherein the film has a thickness of 10 to 90 μm, preferably of 30 to 60 μm.
27. The method according to one of the preceding points, wherein the film is selected from the group of water-soluble films.
28. The method according to one of the preceding points, wherein the film is selected from the group of water-soluble films comprises polyvinyl alcohol or polyvinyl alcohol copolymers.
29 The method according to one of the preceding points, wherein the film is selected from the group of water-soluble films and comprises at least 30 wt. %, preferably at least 50 wt. %, and in particular at least 70 wt. %, polyvinyl alcohol or polyvinyl alcohol copolymers.
30. The method according to one of the preceding points, wherein the first film is transported continuously in step a).
31. The method according to one of the preceding points, wherein the first film is transported in step a) at a speed of 0.04 m/s, preferably above 0.08 m/s.
32. The method according to one of the preceding points, wherein the heating device has a metal surface.
33. The method according to one of the preceding points, wherein the heating device has a metal surface which comprises aluminum.
34. The method according to one of the preceding points, wherein the heating device has a metal surface which consists of up to at least 70 wt. %, preferably up to at least 90 wt. %, and particularly preferably up to at least 98 wt. % and in particular completely, of aluminum.
35. The method according to one of the preceding points, wherein the surface of the heating device is coated at least in portions.
36. The method according to one of the preceding points, wherein the surface of the heating device is coated at least in portions in the region of the depression.
37. The method according to one of the preceding points, wherein the surface of the heating device is coated over the entire surface in the region of the depression(s).
38. The method according to one of the preceding points, wherein the surface of the heating device is coated in the region of the depression(s) and also in the region of the edge region surrounding the depression.
39. The method according to one of the preceding points, wherein the at least one depression is filled to at least 60 vol. %, preferably to at least 80 vol. %, and in particular completely with the coating material.
40. The method according to one of the preceding points, wherein the surface of the heating device is coated at least in portions and the coating covers 5 to 80%, preferably 10 to 70%, and in particular 20 to 50% of the surface region of the heating device which is brought into contact with the film in step b).
41. The method according to one of points 34 to 40, wherein the coating material is selected from the group consisting of metals.
42. The method according to one of points 34 to 40, wherein the coating material is selected from the group consisting of polymers.
43. The method according to one of points 34 to 40, wherein the coating material is selected from the group consisting of silicones.
44. The method according to one of points 34 to 40, wherein the coating material is selected from the group consisting of rubbers.
45. The method according to one of points 34 to 44, wherein the coating has a thickness of 100 to 4000 μm, preferably of 200 to 2000 μm.
46. The method according to one of points 34 to 45, wherein the coating has a lower degree of thermal conductivity than the metal base surface.
47. The method according to one of points 34 to 46, wherein the coating has a lower heat transfer coefficient than the metal base surface.
48. The method according to one of points 34 to 47, wherein the coating is joined to the base surface by means of an adhesive connection.
49. The method according to one of points 34 to 48, wherein the coating is joined to the base surface by means of a clamping connection.
50. The method according to one of the preceding points 34 to 49, wherein the coating is joined to the base surface by means of a plug connection.
51. The method according to one of points 34 to 50, wherein the coating in step b) is in contact with the surface portion of the water-soluble film which is molded into the cavity of the deep-drawing depression in step e).
52. The method according to one of the preceding points, wherein the first water-soluble film is brought into contact with the heating device only on one side in step b).
53. The method according to one of the preceding points, wherein the upper side of the water-soluble film is brought into contact with the heating device in step b).
54. The method according to one of the preceding points, wherein the heating device is lowered in the direction of the film in step b).
55. The method according to one of the preceding points, wherein the surface of the heating device has bores by means of which gas located between the heating device and film can be discharged.
56. The method according to point 55, wherein the bores are 60%, preferably 90%, in particular 95%, and very particularly preferably completely, outside the depressions.
57. The method according to one of the preceding points, wherein, in step b), the film is brought into contact with the heating device by the action of a negative pressure.
58. The method according to one of the preceding points, wherein, in step b), the film is kept in contact with the heating device by the action of a negative pressure.
59. The method according to one of points 57 or 58, wherein a pressure of 200 to 800 mbar, preferably 400 to 700 mbar, is built up in step b) between heating device and water-soluble film.
60. The method according to one of the preceding points, wherein the water-soluble film is heated over a period of 0.5 to 7 seconds, preferably 1 to 6 seconds, and in particular 2 to 5 seconds, in step c).
61. The method according to one of the preceding points, wherein the film is located in step c) below the heating device and above the deep-drawing die used in step e).
62. The method according to one of the preceding points, wherein the film is located in step c) below the heating device and above the deep-drawing die used in step e), and the distance between the surface of the heating device and the surface of the deep-drawing die is less than 10 mm, preferably less than 5 mm, and in particular between 0.1 and 2 mm, particularly preferably between 0.2 and 1 mm.
63. The method according to one of the preceding points, wherein the negative pressure between the heating device and the water-soluble film is eliminated in step d).
64. The method according to one of the preceding points, wherein the negative pressure between the heating device and the water-soluble film is eliminated in step d) and the heating device is simultaneously or subsequently raised.
65. The method according to one of the preceding points, wherein a negative pressure is built up between the film and the deep-drawing die in step e) for a duration of 0.5 to 7 seconds, preferably 1 to 5 seconds.
66. The method according to one of the preceding points, wherein a pressure of 100 to 600 mbar, preferably of 200 to 400 mbar, is built up between the film and the deep-drawing die in step d).
67. The method according to one of the preceding points, wherein the water-soluble film is molded in step e) to form a receiving container comprising at least two, preferably at least three, and in particular at least four, receiving chambers.
68. The method according to one of the preceding points, wherein the receiving container has a filling volume of 2 to 50 ml, preferably of 10 to 40 ml, and in particular of 13 to 25 ml, in step e).
69. The method according to one of the preceding points e, wherein the receiving chamber(s) has (have) a filling volume of 2 to 8 ml, preferably of 3 to 7 ml, in step e).
70. The method according to one of the preceding points, wherein the receiving container has at least two, preferably at least three, and in particular at least four, receiving chambers, and the ratio of the volume of the largest receiving chamber to the volume of the smallest receiving chamber is 4:1 to 1:1, preferably 3:1 to 1:1.
71. The method according to one of the preceding points, wherein, in step e), the surface of the film is increased by at least 80%, preferably at least 120%, in particular 120 to 300%, particularly preferably 180 to 260%.
72. The method according to one of the preceding points, wherein the water-soluble film has an overall stretching factor of 1.8 to 2.6 after step e).
73. The method according to one of the preceding points, wherein the film has a maximum local stretching factor of 1.8 to 4, preferably of 2 to 2.8, after step e).
74. The method according to one of the preceding points, wherein the metallic surface of the heating device has a temperature in the range of 23 to 150° C., preferably of 80 to 135° C.
75. The method according to one of the preceding points, wherein a two-dimensional structure comprising at least 14, preferably at least 20, receiving containers is formed in step e).
76. The method according to one of the preceding points, wherein, in step e), a two-dimensional structure is formed, in which the receiving containers are arranged in rows.
77. The method according to one of the preceding points, wherein, in step e), a two-dimensional structure is formed, in which the receiving containers are arranged in rows that run orthogonally to the transport direction of the film.
78. The method according to one of the preceding points, wherein, in step e), a two-dimensional structure is formed, in which the receiving containers are arranged in rows that run orthogonally to the transport direction of the film and are respectively offset from one another by a third of the width of a receiving container, preferably by half the width of a receiving container.
79. The method according to one of the preceding points, wherein, in step e), a two-dimensional structure is formed, in which each receiving container is adjacent to at least one intermediate region, which in turn is surrounded by three receiving containers.
80. The method according to one of the preceding points, wherein the at least one receiving chamber of the receiving container is filled with a detergent or cleaning agent in a further step f).
81. The method according to one of the preceding points, wherein the at least one receiving chamber of the receiving container is filled in a further step f) and the filled receiving chamber is sealed in a subsequent step g) by means of a second film, preferably by means of a water-soluble film.

### EXAMPLES

A water-soluble polyvinyl alcohol film (thickness 88 μm) was heated by means of varying heating devices and subsequently formed by the action of a negative pressure to form a drop-shaped receiving chamber. The temperature of the heating plate was 120° C. With the exception of the heating device used, the process parameters used in the tests were identical.

The following two heating devices were used:
Heating device 1: completely planar heating plate (aluminum)
Heating device 2: heating plate (aluminum) with a depression (maximum depth 1 mm), the outline of which is adapted to the drop-shaped receiving chamber with a reduction factor of 0.8.

After the deep-drawing process, the film thickness in the receiving chambers was determined by optical methods (film thickness analyzer) along a cross section orthogonal to the longitudinal axis of the drop. The film thickness was measured in each case along the cross section at nine measuring points that are equidistant from one another.

### Film Thickness ([μM])

| | 1 | 2 | 3 | 4 | 5 | 6 | 7 | 8 | 9 |
|---|---|---|---|---|---|---|---|---|---|
| Heating | 34.6 | 29.6 | 27.1 | 24.4 | 25.9 | 24.7 | 24.1 | 27.1 | 33.3 |
| device 1 | | | | | | | | | |
| Heating | 36.6 | 34.1 | 32.0 | 35.0 | 35.0 | 34.6 | 25.9 | 33.7 | 43.8 |
| device 2 | | | | | | | | | |

The receiving chambers obtained by means of the heating plate provided with depressions are characterized by a higher film thickness when the starting film is identical. Portion units which were obtained by filling with a liquid detergent and subsequent sealing by means of a second water-soluble film had an improved mechanical stability.

1. A method for producing a portion unit having at least one filled receiving chamber surrounded by a film, comprising the steps of:
a) transporting a first film in the direction of a heating device;
b) bringing the first film into contact with a surface of the heating device;
c) heating the first film using the heating device;
d) breaking the contact between the first film and the heating device;
e) molding the first heated film into the cavities of a deep-drawing die to form a receiving container comprising at least one receiving chamber;
f) filling the at least one receiving chamber;
g) optionally sealing and separating the filled receiving containers to form the portion unit,
wherein the surface region of the heating device that is brought into contact with the film has at least one depression and the at least one depression is covered in step b) by the subregions of the first film which are molded into the cavity of the deep-drawing die in step e).

2. The method according to claim 1, wherein the opening area of the at least one depression is smaller than the opening area of the cavity.

3. The method according to claim 1, wherein the outline of the opening area of the depression is modeled on the outline of the opening area of the cavity.

4. The method according to claim 1, wherein the outline of the opening area of the depression is obtained from the outline of the opening area of the cavity by a reduction factor of 0.4 to 0.95.

5. The method according to claim 1, wherein the depression has a hemispherical, compressed hemispherical, elongated hemispherical or compressed and elongated hemispherical three-dimensional shape.

6. The method according to claim 1, wherein the depression has a maximum depth, (measured as an orthogonal distance between the opening area and the bottom surface of the depression, from 0.5 to 7 mm.

7. The method according to claim 1, wherein the ratio of the maximum depth of the depression in step b) to the maximum depth of the cavity in step e) is 2:3 to 1 to 5.

8. The method according to claim 1, wherein the depression has a bottom surface which continuously descends from its rim down to its lowest point.

9. The method according to claim 1, wherein the portion unit has at least two, receiving chambers, wherein the heating device has a number of depressions corresponding to the number of receiving chambers, which depressions are covered in step b) by the subregions of the first film which are molded into the cavity of the deep-drawing die in step e) to form the at least two, receiving chambers.

10. The method according to claim 1, wherein the film is selected from the group of water-soluble films.

11. The method according to claim 1, wherein the surface of the heating device is coated at least in portions in the region of the depression.

12. The method according to claim 1, wherein the surface of the heating device is coated over the entire surface in the region of the depression(s).

13. The method according to claim 1, wherein the film is located in step c) below the heating device and above the deep-drawing die used in step e), and the distance between the surface of the heating device and the surface of the deep-drawing die is less than 10 mm.

14. The method according to claim 1, wherein the first water-soluble film is brought into contact with the heating device only on one side in step b).

15. The method according to claim 1, wherein the heating device comprises a metallic surface and the metallic surface of the heating device has a temperature in the range of 23 to 150° C.
